(19) United States
(12) Patent Application Publication
(10) Pub. No.: US 2003/0150937 A1
(43) Pub. Date: Aug. 14, 2003

(54) Nozzle arrangement

(76) Inventors: Keith Laidler, Stourbridge (GB); Andrew Yule, Derbyshire (GB)

Correspondence Address: PILLSBURY WINTHROP, LLP, P.O. BOX 10500, MCLEAN, VA, 22102, US

(21) Appl. No.: 10/276,063

(22) PCT Filed: May 10, 2001
(86) PCT No.: PCT/GB01/02036

(30) Foreign Application Priority Data
May 10, 2000 (GB) 0011218.5

(51) Int. Cl. B05B 7/32

(52) U.S. Cl. 239/340; 239/337

(57) ABSTRACT

A nozzle arrangement which is suitable for use in the generation of a spray or aerosol and which is adapted for connection to a fluid supply, the nozzle arrangement including a fluid inlet through which fluid enters the arrangement from the fluid supply and fluid outlet through which the fluid is ejected from the nozzle arrangement, fluid inlet and fluid outlet being connected to a fluid flow passage through which, in use, fluid flows from the inlet to the outlet, wherein the nozzle arrangement includes control means provided in the passage which, in use, acts to modify the flow characteristics of the fluid in the fluid flow passage to effectively control fluid droplet size produced in the spray or aerosol by the nozzle arrangement.

This invention relates to improvements in or relating to a nozzle arrangement.

Nozzle arrangements are conventionally used to control the ejection of fluids from a pressurised container such as a so called “aerosol can” and can also be used in industrial apparatus to control the ejection of pressurised fluids in many different applications.

Conventional nozzle arrangements generally produce a spray or aerosol which comprises a fine mist of suspended fluid droplets whose size characteristics vary in accordance with a normal distribution.

Problems arise with conventional nozzle arrangements insofar as droplet diameters in the spray or aerosol produced can be below approximately 6.3 μm and droplets of such a size can be inhaled by any person in the vicinity of the spray or aerosol. This is a particular problem when considering nozzle arrangements on aerosol cans where in the case of, for example, a can of polish, paint, adhesive, deodorant or hairspray, components of the contents of the can can be toxic.

Problems also arise with conventional nozzle arrangements in which inhaling is not a problem in that it can be necessary to ensure that the droplets produced are of a preferred size to ensure the maximum effectiveness of the spray or aerosol for its intended purpose. Thus for example, for air fresheners it has been found that the smaller the droplet size the more effective the fragrancing. In this case, it is desirable that a maximum amount of droplets have a small droplet size to ensure effectiveness.

A further problem which arises with conventional nozzle arrangements arises when a compressed gas is used as a propellent in an aerosol can. Because a compressed gas “pushes” the contents out of a can rather than emerging with the droplets from the can as with other propellents such as liquid petroleum gas (LPG), the nozzle arrangement is more prone to blocking since the contents are not contained within a liquid propellent. A still further problem is that the average droplet size produced with a conventional nozzle using compressed gas as a propellent is approximately 80 μm whereas an average droplet size of approximately 30 μm is required. Further as the can empties, the pressure in the can decreases leading to an undesirable increase in average droplet size.

It is accordingly an object of the present invention to provide a nozzle arrangement in which the above mentioned problems are obviated or are at least minimised.

According to a first aspect of the invention there is provided a nozzle arrangement which is suitable for use in the generation of a spray or aerosol and which is adapted for connection to a fluid supply, the nozzle arrangement including a fluid inlet through which fluid enters the arrangement from the fluid supply and a fluid outlet through which the fluid is ejected from the nozzle arrangement, said fluid inlet and said fluid outlet being connected by a fluid flow passage through which, in use, fluid flows from the inlet to the outlet, wherein the nozzle arrangement includes control means provided in the passage which, in use, acts to modify the flow characteristics of the fluid in the fluid flow passage to effectively control fluid droplet size produced in the spray or aerosol by the nozzle arrangement.

With this arrangement it is possible to effectively control droplet size in a spray or aerosol produced by the nozzle arrangement thereby minimising problems of unwanted or undesirable inhaling of droplets and allowing maximisation of the effectiveness of the spray or aerosol for its intended purpose. Further, additionally, by controlling droplet size in the passage in conjunction with in the outlet, it permits compensation for the pressure drop which occurs in the arrangement when compressed gas is used as a propellant.

The control means preferably comprises one or more of the following:

a) an expansion means in which a dimension of the passage transversely to the direction of fluid flow is increased relative to the same dimension of the remainder of the passage;

b) inner orifice means in which the dimension of the passage transversely to the direction of fluid flow is decreased relative to the same dimension of the remainder of the passage;

c) a multiple channel means wherein at least a part of the passage is divided into from 2 to 12 channels each of which has a decreased dimension transversely to the direction of fluid flow relative to the same dimension of the remainder of the passage;

d) a dog leg means in which the flow through the passage is redirected in a direction substantially transversely to the direction of flow in the passage over the length of the means;

e) a swirl means wherein rotational flow is induced in the fluid about the direction of flow of fluid in the passage; and/or

f) venturi means comprising a narrow passage broadening to a relative wide passage with a narrow air inlet entering the passage near the point at which the passage broadens.

It will be appreciated that any one or more of the above mentioned control means can be used as desired or as appropriate to suit the application in which the nozzle arrangement is being used and in particular multiple identical or similar types of the same control means may be used together in the same nozzle arrangement.

Preferably the expansion means is disposed adjacent said fluid outlet, furthermore said expansion means may form a chamber of substantially circular shape.

The nozzle arrangement may preferably have more than one fluid flow passage and in these circumstances the nozzle arrangement may have more than one fluid inlet and/or outlet. Where the nozzle arrangement has two or more passages, the arrangement preferably further includes a selection means at the, or each, fluid inlet which is operable to select through which of the fluid flow passages, the fluid flows. For example, the selection may be made according to the pressure or flow rate of the fluid. Where the nozzle arrangement has two or more fluid flow passages, the nozzle arrangement may comprise a fluid outlet for each fluid flow passage or, alternatively, the respective fluid flow passages may combine at a single fluid outlet.

Particularly advantageous results are obtained from the nozzle arrangement which includes a control means of the type a) and/or of the type b). Most advantageous results are obtained by inclusion of a control means of the type can a) and a control means b), the type a) control means being closest to the fluid outlet and the type b) control means being closest to the fluid inlet of the fluid flow passage.

For a nozzle arrangement for use with an aerosol or spray can containing a polish, paint, adhesive, deodorant or hairspray, control means a), b) and/or d) have been found to give particularly effective results. A nozzle arrangement which includes such control means in combination, preferably in the sequence d), b) and/or a) from the fluid inlet to the fluid outlet reduces the proportion of inhalable droplets in the aerosol or spray generated in use by the nozzle arrangement. In fact using this type of nozzle arrangement, the proportion of inhalable droplets in the aerosol or spray generated when the fluid supply is at maximum pressure, can be arrangement to be less than 15%, preferably arranged to be less than 10%, and most preferably less than 7% as measured by the method described below. It has further been found advantageous to include a throttle device before said control means type d) in this arrangement which throttle device reduces pressure in the flow and leads to an enhancement of the control of the fluid flow in subsequent control means types b) and a). Preferably the throttle device comprises a narrowing of the fluid flow passage.

For a nozzle arrangement for use with an aerosol can containing an air freshener or for a pharmaceutical application, it has been found that to give particularly effective results controls means a), c) e) and/or f) can be used. This is because when they are used in a nozzle arrangement, the droplets of the spray produced by the nozzle arrangement are smaller and the droplet size distribution curve is narrower. The nozzle arrangement, in this case, preferably also has a narrower fluid outlet than in other embodiments. Furthermore, for this use, more than one fluid flow passage may be present and no selection means may be used to select the fluid flow passage through which fluid flows.

For a nozzle arrangement for use with an aerosol or spray can using a compressed gas propellent, the provision of more than one fluid flow passage has been found to be advantageous, and for example, two or three fluid flow passages may be used, each with a separate fluid outlet. The control means used in the fluid flow passages will vary according to the application of the aerosol or spray.

For a nozzle arrangement for use with an aerosol can containing an insecticide, preferably more than one fluid flow passage is used and it has been found that more than one fluid outlet is advantageous as are control means a) and b) or c).

For a nozzle arrangement for use in industry, it has been found that control means a), b), c), e) and f) can be used to generate a spray or aerosol with an average droplet size (as measured using the method described below) of less than 80 μm at a pressure of less than 20 bar and typically the average droplet size obtained would be 10 to 30 μm at a pressure of 2 to 5 bar. Being able to produce such a fine spray at a relatively low pressure is advantageous as it reduces the wear on the nozzle arrangement.

Preferably the fluid outlet of the nozzle arrangement is covered by a moveable hinged flap wherein, when in a closed position, affords protection to the fluid outlet.

The nozzle arrangement is preferably formed by at least two interconnected parts and the parts may be movable apart to enable cleaning of the nozzle arrangement to take place.

Most preferably, the nozzle arrangement is formed by two parts interconnected by a hinge to enable the parts to be moved towards and away from each other to enable cleaning to be effected.

Preferably one or both of said interconnected parts include a seal which when the parts are in the closed position prevents fluid in the nozzle arrangement from leaking out.

One advantage of manufacturing the nozzle arrangement in such a two part form is that it can be done very cheaply.

The actuator and spray-through cap according to the second and third in the aspects of the invention are optionally made either with the nozzle arrangement according to the invention forming an integral part of the constriction or alternatively the nozzle arrangement can be added subsequently as an attachment thereto.

In each of the control means of any of types a)-f), it may be possible to modify the flow of fluid in the control means advantageously by suitable adaption of an inner surface thereof. For example, a textured inner surface may be provided or alternatively projections e.g. spikes can be provided which induce turbulence into the fluid flow though the respective control means.

The invention will now be described further with reference to the accompanying drawings in which:—

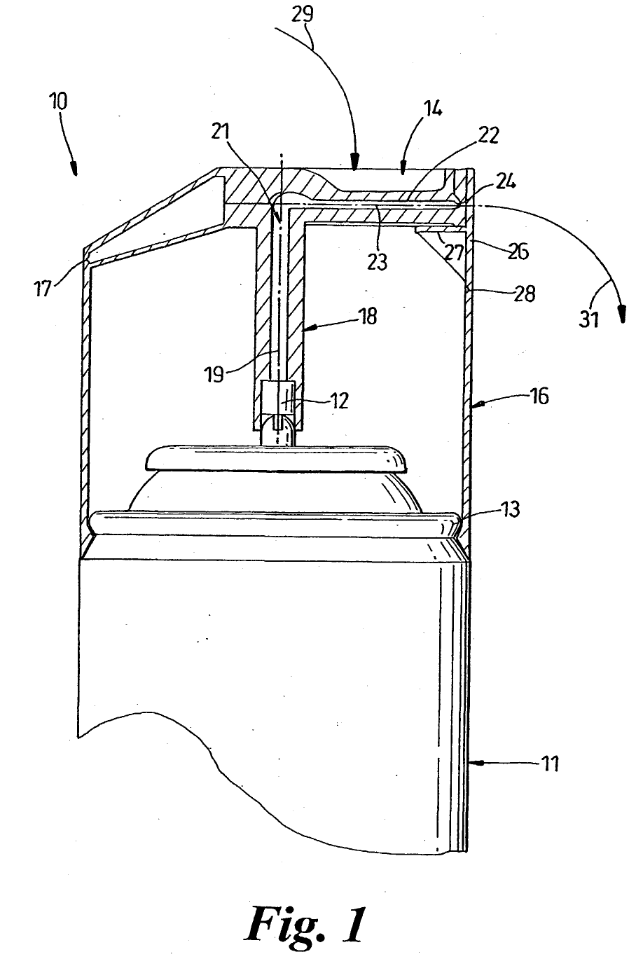

FIG. 1 is a side view partly in cross section showing a conventional spray-through cap mounted on a conventional pressured container;

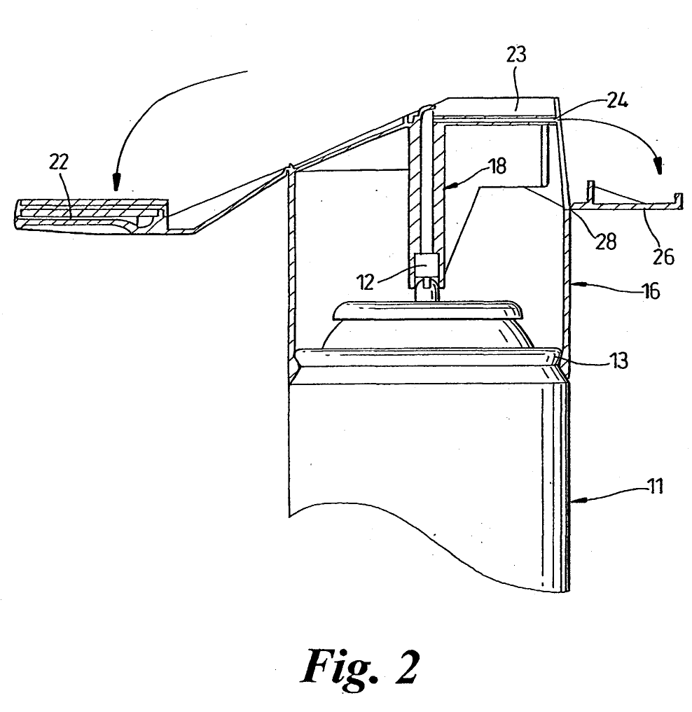

FIG. 2 is a side view partly in cross section of the spray-through cap of FIG. 1 in an “open” configuration;

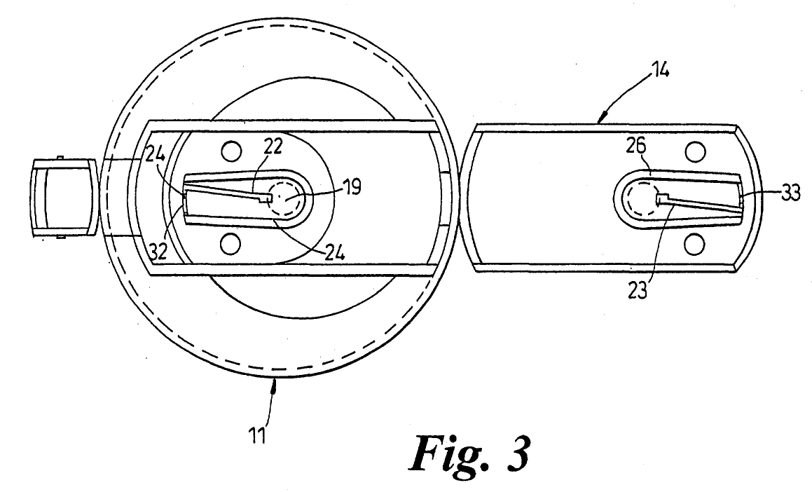

FIG. 3 is a plan view of the spray-through cap of FIG. 2;

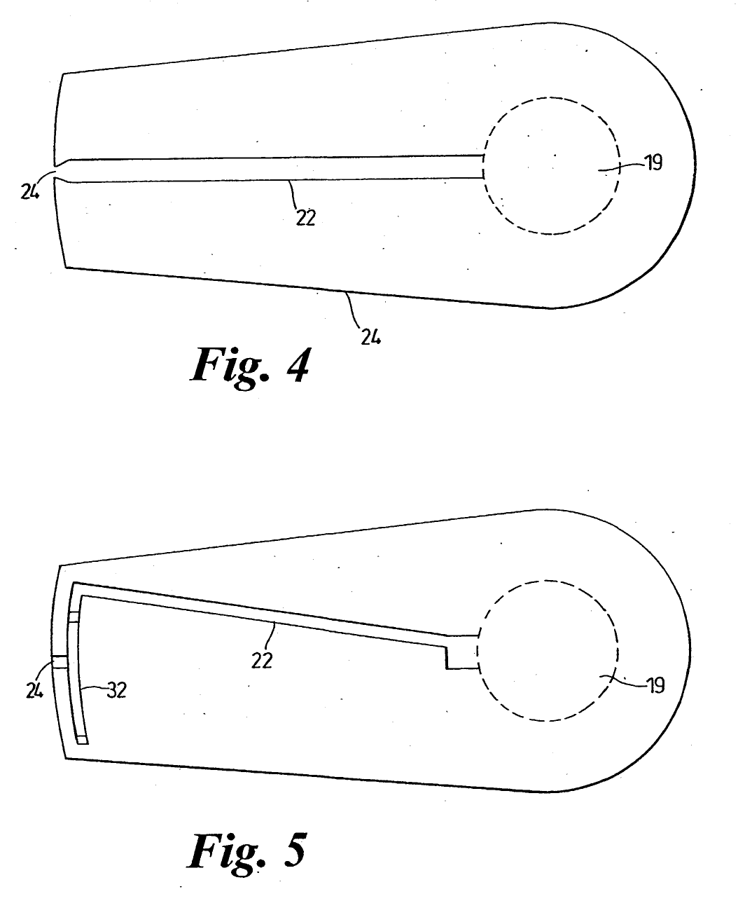

FIG. 4 is a cross-sectional view along X-X¹ of the conventional nozzle arrangement as show in FIG. 2;

FIG. 5 is a cross-sectional view, similar to that of FIG. 4, of an alternative form of a conventional nozzle arrangement;

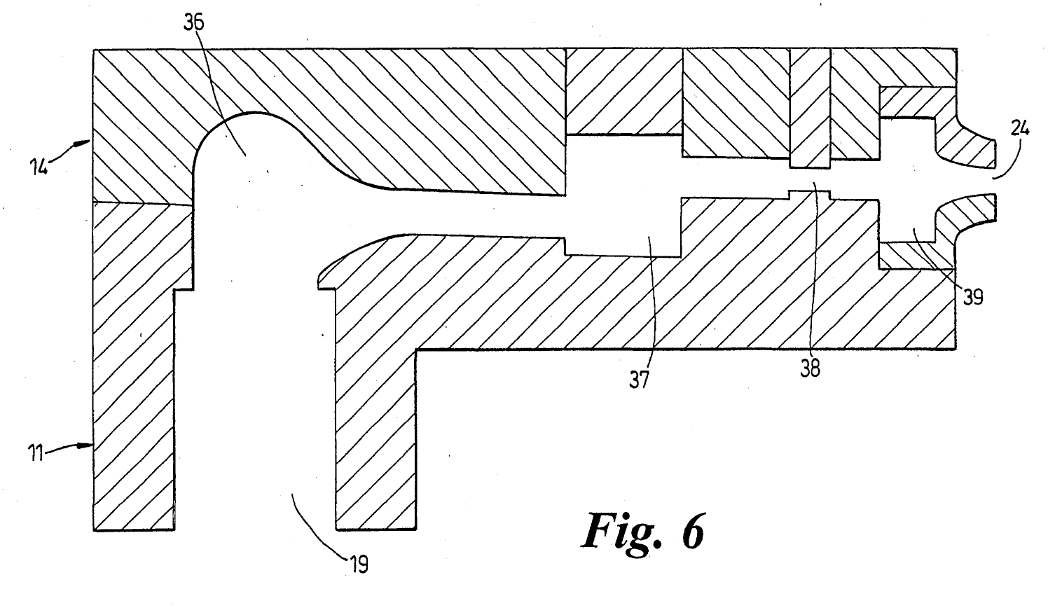

FIG. 6 is a, side view, in cross section, of a part of a fluid flow passage of a first embodiment of nozzle arrangement according to the invention;

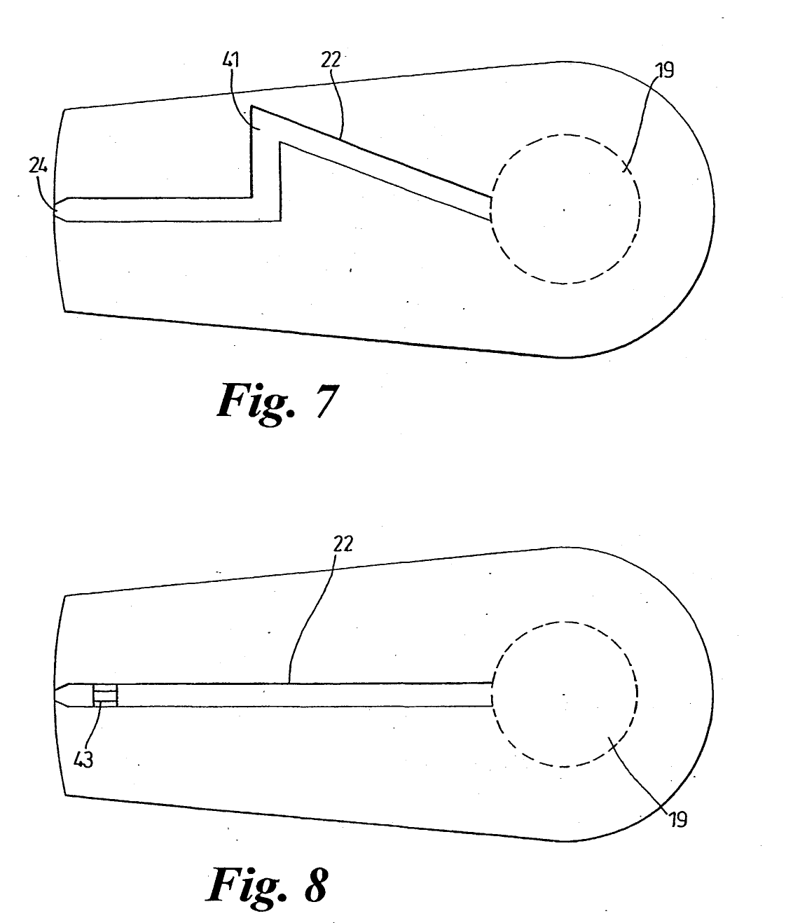

FIG. 7 is a, side view, in cross section, of a part of a fluid flow passage of a second embodiment of nozzle arrangement according to the invention;

FIG. 8 is a, side view, in cross section, of a part of a fluid flow passage of a third embodiment of nozzle arrangement according to the invention;

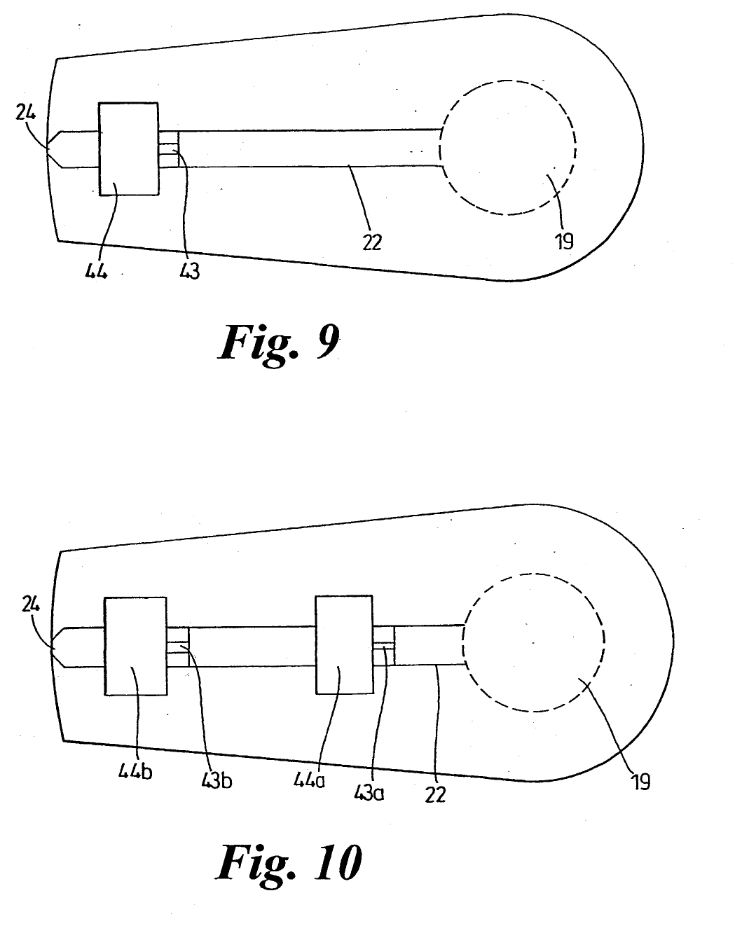

FIG. 9 is a, side view, in cross section, of a part of a fluid flow passage of a fourth embodiment of nozzle arrangement according to the invention;

FIG. 10 is a, side view, in cross section, of a part of a fluid flow passage of a fifth embodiment of nozzle arrangement according to the invention;

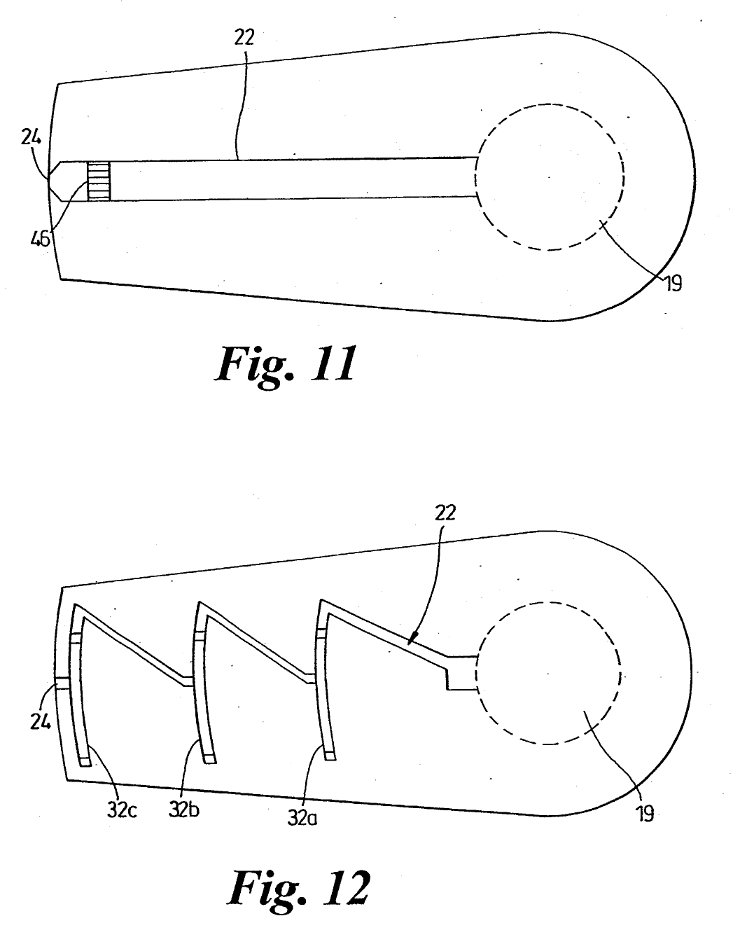

FIG. 11 is a, side view, in cross section, of a part of a fluid flow passage of a sixth embodiment of nozzle arrangement according to the invention;

FIG. 12 is a, side view, in cross section, of a part of a fluid flow passage of a seventh embodiment of nozzle arrangement according to the invention;

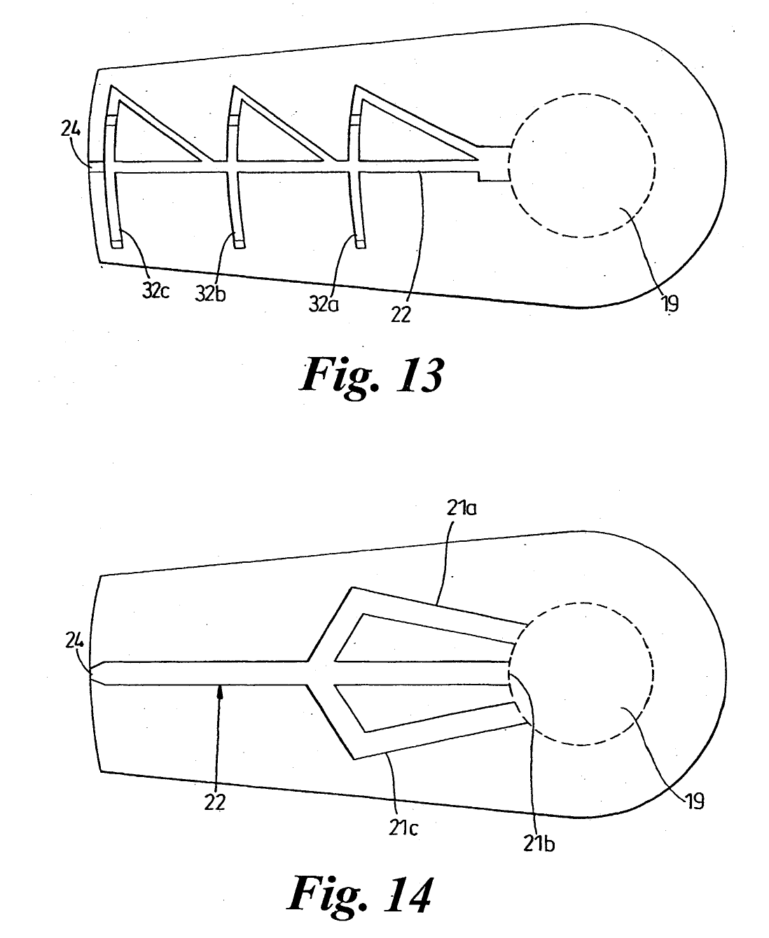

FIG. 13 is a, side view, in cross section, of a part of a fluid flow passage of a eighth embodiment of nozzle arrangement according to the invention;

FIG. 14 is a, side view, in cross section, of a part of a fluid flow passage of a ninth embodiment of nozzle arrangement according to the invention;

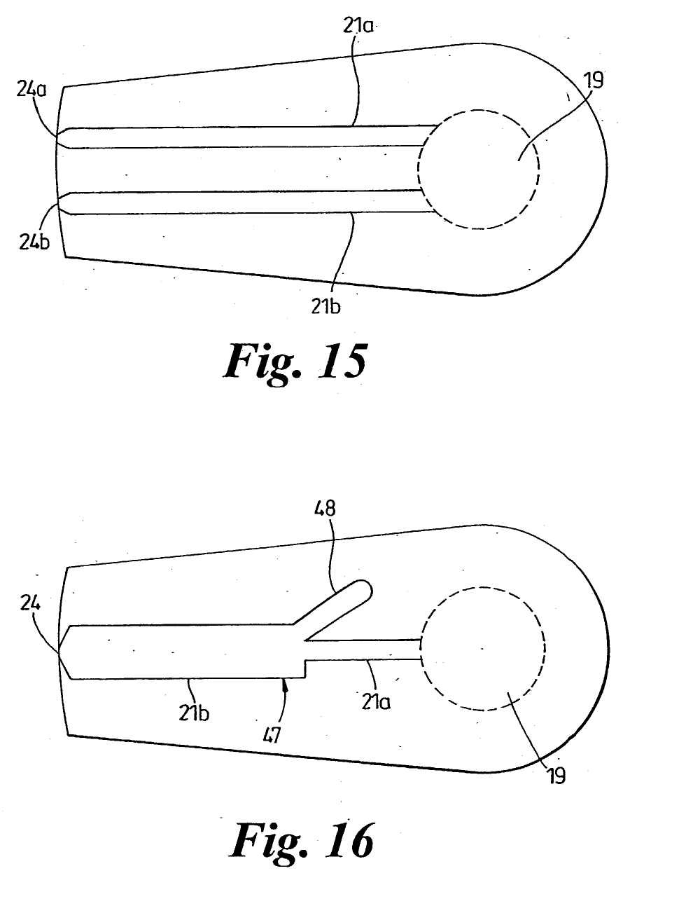

FIG. 15 is a, side view, in cross section, of a part of a fluid flow passage of a tenth embodiment of nozzle arrangement according to the invention;

FIG. 16 is a, side view, in cross section, of a part of a fluid flow passage of a eleventh embodiment of nozzle arrangement according to the invention;

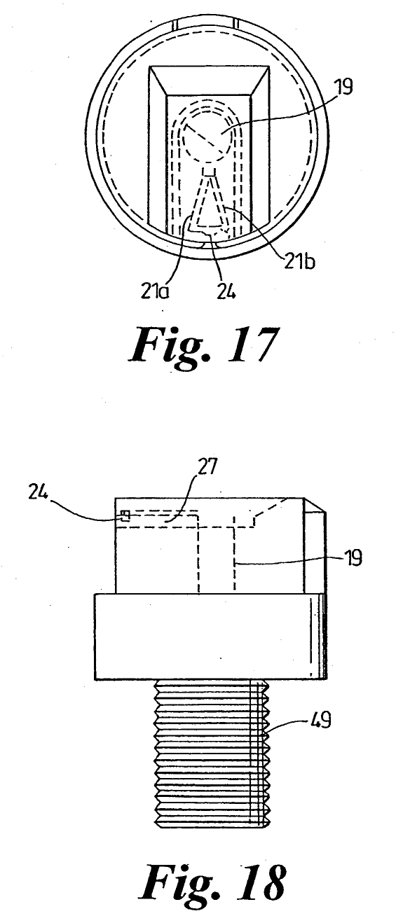

FIG. 17 is a plan view of a conventional industrial nozzle arrangement; and

FIG. 18 shows a side elevation of a conventional industrial nozzle arrangement.

Referring now to the drawings, there is shown in FIGS. 1 and 2 a conventional resilient spray-through cap 10 mounted on conventional canister 11 which contains fluid under pressure. The canister has an outlet 12 through which fluid under pressure can exit the canister 11 upon actuation. The cap 10 is mounted on the canister 11 by resilient engagement with a lip 13 on the canister 12.

The cap 10 is of two part form and comprises a closure 14 which is connected to a main body 16 by way of a resilient hinge 17. The cap 10 also includes a downwardly extending tubular member 18 which, when the cap 10 is mounted on the canister 11, engages with the outlet 12 to allow actuation thereof by depressing the cap downwards. The tubular member 18 has a bore 19 thereto which forms a part of a fluid flow passage 21. A lower surface of the closure 14 and an upper surface of the body 16 have respective grooves 22, 23 therein which, when the closure 14 is in a closed position, as shown in FIG. 1, define a part of the fluid flow passage 21. The bore 19 of the tubular member 18 and the two grooves 22, 23 respectively in the lower surface of the closure 14 and upper surface of the body 14 form a fluid flow passage from the outlet 12 of the canister 11 to a fluid flow outlet 24 of the nozzle arrangement.

The body 16 of the cap also includes a hinged flap 26 which is shown in a closed position in FIG. 1. The flap 26 includes a projecting lip 27, which, when in closed position, prevents operation of the cap. The flap 26 when closed covers fluid outlet 24 and can be opened by pivoting around a hinge 28 which connects the flap 26 to the body 16. When open the fluid outlet 24 is exposed.

In use, the hinged flap 26 is opened to expose the fluid outlet 24 and then the upper surface of the closure 14 is depressed as illustrated by arrow 29. Depressing the top surface of the closure 14 causes tubular member 18 to actuate the canister outlet 12 releasing the fluid from the canister 11 into the fluid flow passage 21. The resilient nature of the cap 10 facilitates this action. Once released into the fluid flow passage 21, the pressurised fluid flows to the fluid outlet 24 and is ejected as indicated by arrow 31. Once used, the closure 14 can be opened by pivoting about the hinge 28 to enable cleaning of the grooves 22, 23 to take place.

FIG. 3 shows a plan view of the cap 10 of FIG. 1 and FIG. 2 and the same reference numerals have the same meaning as in FIGS. 1 and 2. The grooves 22, 23 respectively in the lower surface of the closure 14 and upper surface of the body 11 which form a part of the fluid flow passage 21 are shown more clearly in this Figure. It can be seen that in a conventional cap, the grooves 22, 23 in the closure 14 and upper surface of the body 11 include portions 32, 33 which are transverse to the remainder of the grooves 22, 23 and which, when the closure 14 is in closed position (FIG. 1) form a swirl chamber which induces rotational movement in the fluid upon ejection from the fluid outlet 24. Each groove 22, 23 is surrounded by a horseshoe shaped seal 24, 26 which prevents fluid leaking from the nozzle arrangement.

FIG. 4 shows a plan view of a part of a cap of the type shown in FIG. 3 in which there are no transverse portions to the grooves 22 (of which only the groove 22 in the body 11 is shown in the Figure) and therefore no swirl chamber is present. In use, a nozzle arrangement of the kind produces a spray with a full but uneven cone.

FIG. 5 shows a plan view of a part of the cap of FIG. 3 showing more clearly the transverse portion 32 of the groove 22 on the upper surface of the body 11. In use, a nozzle arrangement as illustrated in FIG. 5 produces a spray with a hollow cone.

FIG. 6 shows a first embodiment of nozzle arrangement in accordance with the present invention. The Figure represents a cross section through the closure 14 and body 11 of a cap 10 of the type shown in FIG. 1. Only a part of the tubular member 18 is shown for clarity. In the first embodiment of the invention, the fluid flow passage 21 is modified to control the characteristics of the aerosol produced from fluid outlet 24. The passage comprises a first chamber 36, a dog leg 37, an inner orifice 38, an expansion chamber 39 and a constricted nozzle arrangement outlet 24. The first chamber 36 has smooth curved walls thereto which assist in the prevention of the formation of fluid droplets of inhalable size. Conventional nozzle arrangements, where they have such a chamber due to the manner of manufacture have a uneven surface which increases the likelihood of smaller inhalable droplets being formed. The dog leg 37 also acts to reduce the quantity of inhalable droplets and also reduces the effects of any variation in distance between the chamber 36 and outlet 24 which can occur with different size aerosol cans. The inner orifice 38 forms a spray in the passage 21 and the spray mixes with the spray from the outlet 24 to cause smaller droplets to coalesce such that small inhalable droplets are reduced. The spray formed at orifice 38 is spinning and spins with in the expansion chamber 39 which acts to form an even spray when this emerges from outlet 24. The distance between chamber 39 and outlet 24 can be carried to achieve a desired angle of spray from the outlet 24.

It has been found that, in use, a nozzle arrangement with the combination of control modifications illustrated in FIG. 6 produces an aerosol or spray where the average proportion over the lifetime of the aerosol of droplets having a diameter below 6.3 μm (as measured using the technique described below) is reduced from 25% (for a normal nozzle arrangement such as that illustrated in FIG. 5) to below 6.5%.

FIG. 7 shows a plan view of part of a second embodiment of nozzle arrangement according to the invention. The fluid flow passage 21 in this embodiment is modified by the presence of a dog leg 41. The dog leg 41 assists in negating any effect the dimensions of the nozzle arrangement has on the droplet distribution in the spray. In use, a nozzle arrangement as illustrated in FIG. 7 is advantageous because the lower tail of the droplet distribution curve is minimised such that the number of droplets having a diameter less than 10 μm and particularly 6.3 μm is reduced.

FIG. 8 shows a plan view of a part of a third embodiment of nozzle arrangement according to the invention. In this embodiment, the fluid flow passage 21 is modified by the inclusion of an inner orifice 43 adjacent the fluid outlet 24. The advantage of the orifice 43 is that it can be used to control the rate of flow through the nozzle arrangement. Normally outlet 24 performs this function. When an orifice 43 is present, outlet 24 can be enlarged to reduce the number of droplets having a diameter less than 6.3 μm without increasing the flow rate. The distance between orifice 43 and outlet 24 has also been found to affect the shape of the droplet size distribution curve. A further advantage is that a nozzle arrangement which includes an orifice 43 is more likely to produce a spray with an even full cone since the orifice 43 acts to fill in the spray with droplets thus producing a full cone.

FIG. 9 shows a plan view of part of a fourth embodiment of nozzle arrangement according to the invention. In this embodiment, the fluid flow passage 21 is modified by the inclusion of an inner orifice 43 followed by an expansion chamber 44. In this embodiment, the expansion chamber 44 enables the effects of the inner orifice 43 described in relation to FIG. 8 to be enhanced.

FIG. 10 shows a plan view of part of a fifth embodiment of nozzle arrangement according to the invention. In this embodiment, fluid flow passage 21 is modified by the inclusion of two combinations of a orifice (43a and 43b) and an expansion chamber (44a and 44b). This arrangement has the advantages o the arrangement of FIG. 9 but because o the use of two combinations the effect achieved is enhanced.

FIG. 11 shows a plan view of part of a sixth embodiment nozzle arrangement according to the invention. In this embodiment, fluid flow passage 21 is modified by having a restrictor 46 in the form of a perforated body which has a number of very fine holes. The advantage of the restrictor 46 is that the average droplet size in the aerosol or spray produced, in use, from a nozzle arrangement illustrated in FIG. 9 is reduced. As an alternative the restrictor 46 could be replaced by a very fine slit to achieve the same effect.

FIG. 12 shows a plan view of a part of a seventh embodiment of nozzle arrangement according to the invention. In this embodiment, fluid flow passage 21 is modified by the inclusion of a number of swirl chambers 32a, 32b and 32c. In the drawing three such swirl chambers are shown although it is possible for one to four such chambers to be used. Advantages of the nozzle arrangement illustrated in FIG. 12 include that the spray produced will be well mixed and have a lower average droplet size. This arises because the swirling action results in the product contained in the can being broken up to a greater extent.

FIG. 13 shows a plan view of a part of a eighth embodiment of nozzle arrangement according to the invention. In this embodiment, fluid flow passage 21 is modified by, at three points along its length, the fluid flow passage 21 connects to three swirl chambers 32a, 32b and 32c each of which reconnects to the fluid flow passage 21. One advantage of a nozzle arrangement provided with such a passage 21 is that the upper tail of the droplet size distribution curve of the droplets in the spray or aerosol produced by such a nozzle arrangement is minimised. A further advantage is that the spray produced will have a full cone because of the continuous length of the passage 21.

FIG. 14 shows a plan view of a part of a ninth embodiment of nozzle arrangement according to the invention. In this embodiment, fluid flow passage 21 is modified in that it has three arms 21a, 21b and 21c which connect to the bore of the tubular member 19. The three arms 21a, 21b and 21c are arranged so that as the pressurised canister empties and the pressure decreases in the canister, the contents of the container when the canister is used flow down different arms. The arms 21a, 21b and 21c have different configurations so as to cause different effects on the flow of the contents. By having different configurations is meant that each arm 21a, 21b and/or 21c includes appropriate means to modify the flow characteristics of the fluid to ensure that the droplet distribution where the arms recombine to foam passage 21 is the same throughout the life of the canister. This is particularly important when the propellent is compressed gas where usually the droplet distribution will vary enormously during can life. Arms 21a, 21b and 21c need not necessarily combine to reform passage 21. Instead they may lead either together or independently to separate nozzle arrangement outlets.

FIG. 15 shows a plan view of a part of a tenth embodiment of nozzle arrangement according to the invention. In this embodiment, the fluid flow passage 21 is divided into two arms 21a, 21b. The arms 21a and 21b lead from tubular connector 9 to separate fluid outlets 24a and 24b, respectively.

The nozzle arrangement illustrated in FIG. 15 is advantageous in an air freshener application because the outlets 24a and 24b could be constricted to produce droplets of a smaller size. The reduction in the flow rate caused by having two arms 21a and 21b would be compensated for by having two outlets.

The nozzle arrangement illustrated in FIG. 15 is also advantageous for use with a compressed gas aerosol if it is provided with a pressure activated means which determines which of passages 21a and 21b the fluid flows through. To prevent deterioration of the spray characteristics as the pressure in the can drops, flow is switched from one passage to the other when the pressure falls below a predetermined level. Each of the arms 21a or 21b can be modified in any desired appropriate way to modify the characteristics of the aerosol produced by the nozzle arrangement and the modification can be such that the modification to one arm is suitable to work at higher pressures and the modification to the other arm is suitable to work at lower pressures.

Whilst in the embodiments of FIGS. 14 and 15 two or three arms 21a, 21b and 21c are provided, it will be appreciated that any number of arms, as desired or as appropriate can be used. Preferably the number of arms is in the range of 2 to 4.

FIG. 16 shows a plan view of a part of an eleventh embodiment of nozzle arrangement according to the invention. In this embodiment, fluid flow passage 21 is modified by the inclusion of a venturi arrangement 47. Passage 21 is initially narrow 21a and broadens 21b at the point where a passage 48 joins to form the venturi arrangement. Passage 48 leads to a vent in the nozzle arrangement (not shown) and thus provides the venturi arrangement with an air inlet. The advantage of such a nozzle arrangement is that the air flow from passage 48 helps to break up the aerosol leading to a reduction in the average droplet size. This has been found to be useful with compressed gas aerosol cans.

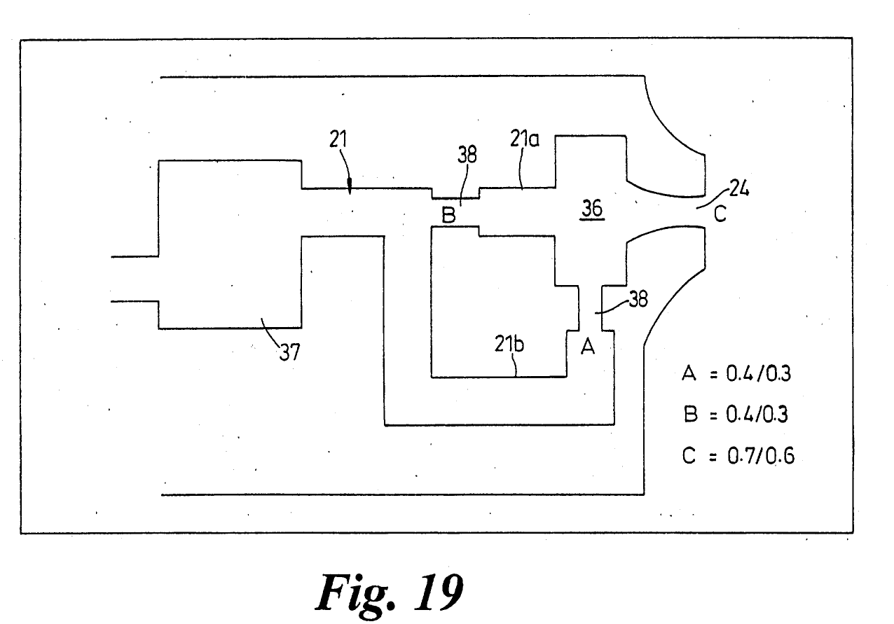

FIG. 19 shows a twelfth embodiment of nozzle arrangement according to the present invention. This arrangement includes an inner orifice 38, expansion chamber 36 and dog leg 37 in the fluid flow passage 21 linked to fluid outlet 24. Between the dog leg 37 and the inner orifice 38, the fluid flow passage 21 splits into two parts, a first part 21a and a second part 21a which respectively deliver fluid to the expansion chamber 36, the fluid from the second part 21b flowing into the expansion chamber 36 substantially perpendicularly to the fluid flowing from the first part 21a into the expansion chamber 36. If desired, a further inner orifice can be provided in the second part 21b and indeed one or more further inner orifices 38 can be provided in either or both of the first or second parts 21a and 21b respectively. The advantage of this construction is that the effect of the two perpendicular fluid flows into the expansion chamber 36 causes the fluid to spin in the expansion chamber 36 which reduces the size of droplets in the fluid. The impact of the two fluid flows in the expansion chamber also assists this respect. As an alternative, the second part 21b can be arranged to part fluid to flow therefrom into the expansion chamber 36 substantially tangentially.

Whilst the above embodiments of nozzle arrangement have been described for use with pressurised canisters, it will be appreciated that the nozzle arrangement of the invention can also be used in an industrial nozzle arrangement which is also used to produce fluid spray or aerosols having particular properties. FIGS. 17 and 18 show embodiments of industrial nozzle in which a nozzle arrangement of the kind of the present invention is present. Thus, as shown in FIG. 18, a fluid supply pipe 49 supplies fluid under pressure to a fluid flow passage 21 of the type mentioned in relation to the other embodiments and the fluid flow passage can be modified in any of the ways mentioned above in relation to the other embodiments to achieve any of the desired effects in the spray or aerosol produced by the nozzle arrangement. In an industrial nozzle arrangement, compressed air can be added to the fluid either at the fluid inlet, fluid outlet or any part of the fluid flow passage as desired or as appropriate.

It will be appreciated that, as mentioned above, there are many ways of modifying the fluid flow passage and each of these ways can be utilised separately or in combination with one or more other ways. In fact, the modifications necessary are chosen dependent on the desired properties of the spray or aerosol produced by the nozzle arrangement.

Droplet size and distribution curves were measured using a Malvern Instruments ST1600 Laser Diffraction instrument. Measurements were made at about 150 mm from its orifice, with the laser beam traversing the cross-section of the spray. A 210 mm focal length lens was used, giving a measurable particle size range 0.5≦D≦188 microns. When testing a nozzle arrangement, the aerosol can was first weighed and measurements were made for the full can (0% discharged) and typically 25%, 50%, 75% and 95% discharged. Flow rate was measured as a function of the percentage discharged, by the timed discharge of a measured mass (obtained by weighing the can). Spray angle was obtained by spraying onto a steel rule at a distance of 40 mm downstream, and visual inspection of the deposition.

It is of course to be understood that the invention is not intended to be restricted to the details of the above embodiment which are described by way of example only.

Thus, for example, as a alternative to using compressed gas or propellant to activate the nozzle arrangement of the invention, a pump mechanism of any suitable form can be used.

1. A nozzle arrangement which is suitable for use in the generation of a spray or aerosol and which is adapted for connection to a fluid supply, the nozzle arrangement comprising a fluid inlet through which fluid enters the arrangement from the fluid supply and fluid outlet through which the fluid is ejected from the nozzle arrangement, said fluid inlet and said fluid outlet being connected to a fluid flow passage through which, in use, fluid flows from the inlet to the outlet, said fluid flow passage further comprising inner orifice means in which a dimension of the passage transversely to the direction of fluid flow is decreased relative to the same dimension of the remainder of the passage, wherein said inner orifice means is adapted to generate a spray within said fluid flow passageway and the nozzle arrangement additionally comprises control means disposed in the fluid flow passage which, in use, acts to modify the size of the fluid droplets produced in the spray.

2. A nozzle arrangement according to claim 1, wherein the inner orifice means causes the formation of a spray at its outlet.

3. A nozzle arrangement according to claim 1 or 2, wherein said control means comprises an expansion means wherein a dimension of the passage transversely to the direction of fluid flow is increased relative to the same dimension of the remainder of the passage and said means extends over a substantial part of a length of said passage and forms a chamber.

4. A nozzle arrangement according to claim 3, wherein the expansion means is closest to the fluid outlet and the inner orifice means is closest to the fluid inlet.

5. A nozzle arrangement according to claim 4, wherein the inner orifice means is positioned adjacent to said expansion means such that, in use, said inner orifice means generates a spray of the fluid passing through the fluid flow passage within said expansion means.

6. A nozzle arrangement according to any one of claims 3 to 5 wherein the expansion means is provided adjacent said fluid outlet.

7. A nozzle arrangement according to any one of claims 3 to 6 wherein the expansion means forms a chamber of substantially circular cross-section.

8. A nozzle arrangement according to any one of claims 1 to 7, wherein the control means comprises a multiple channel means to modify the size of the spray droplets produced, wherein at least a part of the passage is divided into from 1 to 12 channels each of which has a decreased dimension transversely to the direction of fluid flow relative to the same dimension of the remainder of the passage.

9. A nozzle arrangement according to any one of claims 1 to 8, wherein the control means comprises a dog leg means to modify the size of the spray droplets produced, wherein the flow through the passage is redirected in the direction as substantially transversely to the direction of flow in the passage over the length of the means.

10. A nozzle arrangement according to any one of claims 1 to 9, wherein the control means comprises a swirl means to modify the size of the spray droplets produced, wherein rotational flow is induced in the fluid about the direction of flow of fluid in the passage.

11. A nozzle arrangement according to any one of claims 1 to 10, wherein the control means comprises venturi means which further comprises a narrow passage broadening to a relatively wide passage with a narrow air inlet entering the passage near the point at which the passage broadens.

12. A nozzle arrangement as claimed in any preceding claim, wherein said fluid flow passageway comprises, in combination, an expansion means, inner orifice means and a dog leg means.

13. A nozzle arrangement according to claim 12, wherein, from the fluid outlet to the fluid inlet, the fluid flow passage comprises, in the following order, said expansion means, said inner orifice means and said dog leg means.

14. A nozzle arrangement according to claim 13, wherein said fluid flow passage additionally comprises a throttle device positioned between the dog-leg means and said fluid inlet.

15. A nozzle arrangement according to claim 14, wherein said throttle device comprises a narrowing of the fluid flow passage.

16. A nozzle arrangement according to any preceding claim wherein the fluid flow passage comprises, in combination, an expansion means, an inner orifice means, a swirl means and a venturi means.

17. A nozzle arrangement according to any preceding claim, wherein the fluid flow passage comprises, in combination, a first inner orifice means, a first expansion means and a second inner orifice means and a second expansion means.

18. A nozzle arrangement according to claim 17, wherein, from the fluid flow inlet to the fluid flow outlet, said fluid flow passage comprises, in the following order, said first inner orifice means, said first expansion means, said second inner orifice means and said second expansion means and the fluid flow passageway is narrower in said first inner orifice means than in said second inner orifice means.

19. A nozzle arrangement wherein the fluid flow passage comprises, in combination, an expansion means and a plurality of inner orifice means according to any preceding claim.

20. A nozzle arrangement wherein the fluid flow passage comprises, in combination, an expansion means and a swirl means according to any preceding claim.

21. A nozzle arrangement according to claim 20, wherein, from the fluid inlet to the fluid outlet, said fluid flow passage comprises said swirl means, said inner orifice means and said expansion means.

22. A nozzle arrangement according to claim 20, wherein said fluid flow passage comprises a first and a second swirl means.

23. A nozzle arrangement according to claim 22, wherein, from the fluid inlet to the fluid outlet, said fluid flow passage comprises, in the following order, said first swirl means, said inner orifice means and said expansion means and said second swirl means.

24. A nozzle arrangement according to any one of claims 2 to 23 wherein said expansion means is provided with a projection on an inner surface thereof to induce turbulence in the fluid flow.

25. A nozzle arrangement according to any one of the preceding claims, wherein said fluid flow passage additionally comprises a throttle device positioned adjacent to the fluid inlet.

26. A nozzle arrangement according to any one of claims 1 to 25, wherein the fluid outlet is covered by a movable hinge flap which, when in a closed position, affords protection to the fluid outlet.

27. A nozzle arrangement according to any one of claims 1 to 26, wherein the nozzle arrangement is formed by at least two interconnected parts and the parts are movable apart to enable cleaning of the nozzle arrangement.

28. A nozzle arrangement according to claim 27, wherein the nozzle arrangement is formed in two parts interconnected by a hinge to enable the parts to be moved towards and away from each other.

29. A nozzle arrangement according to either claim 27 or claim 28, wherein one or both of said interconnected parts include a seal which when the parts are brought together to form the nozzle arrangement prevent fluid in the nozzle arrangement from leaking out.

30. A nozzle arrangement according to any one preceding claim, wherein the nozzle arrangement has more than one fluid flow passage.

31. A nozzle arrangement according to claim 30, wherein the nozzle arrangement has more than one fluid inlet and/or fluid outlet.

32. A nozzle arrangement according to claim 30 or claim 31, wherein the nozzle arrangement includes a selection means at the, or each, fluid inlet which is operable to select through which of the fluid flow passages the fluid flows.

33. A nozzle arrangement according to claim 32, wherein the selection means operates to select which of the fluid flow passages the fluid flows through according to the pressure of the fluid.

34. A nozzle arrangement according to any one of claims 30 to 33, wherein the nozzle arrangement comprises a fluid outlet for each fluid flow passage.

35. A nozzle arrangement according to claim 30, wherein each respective fluid flow passage combines at a single fluid outlet.

36. A nozzle arrangement according to any one of claims 30 to 34, wherein the nozzle arrangement comprises at least two fluid flow passages each with a separate fluid outlet.

37. A nozzle arrangement according to claim 30, wherein the nozzle arrangement includes three or more fluid flow passages.

38. A nozzle arrangement according to any preceding claim, wherein the inner orifice means is in the form of a slit.
